(19) United States
(12) Patent Application Publication
(10) Pub. No.: US 2003/0177870 A1
(43) Pub. Date: Sep. 25, 2003

(54) High torque power tong

(76) Inventors: Billy W. Neves, Odessa, TX (US); Randolph L. Stuart, Odessa, TX (US)

Correspondence Address: Loren G. Helmreich, BROWNING BUSHMAN P.C., 5718 WESTHEIMER, SUITE 1800, HOUSTON, TX, 77057, US

(21) Appl. No.: 10/053,807

(22) Filed: Nov. 7, 2001

Related U.S. Application Data
(63) Continuation of application No. 09/611,103, filed on Jul. 6, 2000, now abandoned.

(51) Int. Cl. B25B 17/00

(52) U.S. Cl. 81/57.2

(57) ABSTRACT

An open throat power tong 10 as commonly used for making up and/or breaking apart an oilfield tubular connection, comprising a tong body 20, a tong door assembly 40, a partial ring member 30 and a ring segment 150. The partial ring member 30 and ring segment 150 may not be structurally connected and each may support one or more jaw members thereon for gripping a tubular 11. The partial ring member 30 and ring segment 150 may rotate substantially in unison along a substantially common plane and about a common axis, along a defined rotation course through the tong body 20 and door 40. The ring segment 150 may be substantially secured within the door when the door 40 is opened. An improved latch mechanism 100 is included for securing the door 40 to the tong body 20 to facilitate relatively easy closing and latching and unlatching of the door 40 with the tong body 20, and to prevent expansion of the open throat 25 during application of high torque.

### FIELD OF THE INVENTION

The present invention relates to power tongs of the type commonly used to make up and break apart oilfield tubular threaded connections. More particularly, this invention relates to an improved open throat power tong which may be laterally moved on and off a tubular string, and to an improved door for such a power tong which will extend across the open throat when in the closed position and will expose the open throat when in the opened position.

### BACKGROUND OF THE INVENTION

Power tongs have been used for decades to make up and break apart oilfield tubular connections. While such power tongs have a variety of configurations, and different mechanisms for both gripping and rotating an upper tubular pipe relative to a lower tubular pipe, such power tongs generally may be classified as being either the closed throat type or the open throat type. Closed throat power tongs provide a tong body which fully encircles the tubular string, so that repeated oilfield threaded connections pass axially through an opening in the closed throat power tong.

The body of an open throat power tong, on the other hand, typically encircles a majority of the oilfield tubular connection, but an open throat is provided in the tong body to allow the tong to be laterally moved on and off the tubular string. Likewise, a majority of a rotary ring may typically encircle a majority of the tubular and may rotate around the tubular, within the tong body. Most open throat power tongs are provided with a door which accordingly is opened to expose the open throat of the power tong when the tong is not being operated. The door assembly of an open throat power tong is typically closed and latched when the power tong is operated to increase the reliable torque output of the power tong by preventing “spreading” of the open throat and/or to safely retain the tubular within the throat while rotating the tubular. The door assembly provides an open throat tong with the ability to fully encompass a tubular member to aid in safely and securely gripping and rotating the tubular. Also, closing the tong door may increase the safety of the power tong by preventing a tong operator from inadvertently engaging the power tong rotating ring prior to correct tong engagement with the pipe, and may prevent jamming of the rotating ring due to misalignment with the door assembly.

Various types of latching mechanisms have been used in the power tong industry to retain the pivotal door in the closed position. The commonly used latching mechanism in an open throat power tong employs a heavy duty hammer latch mechanism which includes a latch arm pivotally connected to one of a pair of doors positioned on opposing sides of the open throat. Alternatively, a single door may extend across the open throat so that the latch arm on the door engages a lug on the tong body. In either case, a latch head at the end of the latch arm engages a latch lug or stop to retain the door or the pair of doors in the closed position. The latch head and the latch lug typically have planar surfaces which engage when the door or the pair of doors are in the closed position. The heavy duty latch mechanism and door are sufficient to withstand a substantial lateral force, and thus minimize spreading of the open throat of the power tong. To open the doors, the operator manually grasps a handle secured to the latch arm and pulls the latch arm away from the latch stop to disengage the mating surfaces. With the door or doors opened, a power tong may then be moved laterally on and off a tubular string.

When the double door open throat power tong is positioned about the tubular string and prior to activating the partial ring, the door with the latch stop is first closed, then the door with the latch arm is manually closed. The latch arm conventionally includes a spring member which biases the latch arm to the closed position relative to its supporting door. By applying a considerable closing force to the door supporting the latch arm, a cam surface on a latch head engages a corresponding cam surface on the latch stop which causes the latch arm to pivot toward an opened position while the latch head moves radially outward from the latch stop. Once the latch arm is pivotally moved to the opened position, the latch head moves radially inward relative to the latch stop so that the planar surfaces on the latch head and the latch stop engage. The spring on the latch arm may serve to provide additional force which retains the doors closed.

A significant disadvantage of the power tong door discussed above is that it typically requires a relatively large amount of closing force to shut the doors while the latch head moves radially outward with respect to the latch stop, so that the latch head will then be properly positioned so that it may move back radially inward relative to the latch stop and secure the doors closed. This large closing force requires that the door components be sized both for withstanding the spreading force discussed above, and also to ensure that components are sufficiently rugged to withstand the repeated substantially jarring force which these components endure during closing of the door.

A related drawback of this prior art system is that a great deal of effort is required by a tong operator to close the door, which unfortunately increases the tendency for the operator to merely position the door in the partially closed position and not fully latch the door closed. Failure to latch the door closed creates a safety risk, as discussed above, and may also result in tong spreading when high torque is used to make up or break apart the threaded connection.

A second generally distinguishing characteristic between tongs, (other than open/closed throat design), is design of the jaw system. Tongs may generally be classified as either the two jaw system or three jaw system. A two jaw tong system typically includes two sets of gripping jaws segments provided within the tong body, with both sets combining to provide a maximum gripping area of 360 degrees less the circumferential door area. A three jaw tong system typically includes a two jaw system plus a third jaw that is located within the tong door segment, thereby ideally affording substantially 360 degrees of jaw gripping surface to a tubular member.

A drawback of prior art three jaw tongs is that gear pins were required to attach the body ring gear section with the door ring gear section. One gear pin was included on the hinge side of the gear door segment and a second pin was provided on the latch side of the ring gear door segment. A second set of pins or a pin and latch mechanism, were used to pivot and latch the door assembly to the tong body. Each time the door segment were opened or closed, the latch side of the door were unlatched and/or unpinned, as appropriate. In addition, at least one side of the ring gear door segment was also unpinned. Such operations were and are time consuming, and increase the complexity and reliability of the tongs. Additional problems include maintaining proper alignment of gear, door, pin, latch and housing components each time the tong door is closed. Pins typically require a tight fit and alignment between components can be critical to proper rotation of the gear and/or to proper tong operation. If improperly aligned or if the door is improperly closed or latched, the tong gear may seize and lock up the rotational tong components. Operation of a power tong with the door opened may be dangerous and is not recommended except under special circumstances and with appropriate safety precautions. If the tong is operated with the door opened, the rotational components may jam and require some tong disassembly to disengage the jammed components. Also, if operated with the door opened, there is a possibility of the ring segment coming partially or completely out of the tong.

A prior art power tong is incorporated herein by reference, which was filed Jan. 13, 1999, as file number Eckel-71. Eckel-71 discloses a latch mechanism that may require a relatively lower force and effort to open and close the door and latch mechanism.

The disadvantages of the prior art are overcome by the present invention. An improved open throat power tong is disclosed including a door that provides a non-pinned, rotating gear section and a rotating third gripping jaw, within the door section for the power tong. The door of the present invention may significantly increase the area over which the tong grips the tubular, such that an increased make up and/or break out torque may be applied without increasing risk of collapsing or damaging the tubular.

### SUMMARY OF THE INVENTION

An improved open throat power tong for making up and/or breaking apart an oilfield tubular connection includes a tong body having an open throat therein, and a partial ring member having an open throat. The partial ring member having an open throat may be rotatably supported on the tong body for rotating one tubular member relative to another during a connection make up and/or break out operation. At least two heads may be included on the partial ring member that are rotatable with the partial ring for gripping engagement with the upper oilfield tubular. A door is included which may be pivotally connected to the tong body adjacent a side of the open throat, wherein the door extends at least partially across the open throat when in the closed position, and when in the opened position exposes the open throat to enable the power tong to be moved laterally on and off the oilfield tubular. A ring segment is included which may be rotatably supported within the door for rotating in conjunction with the partial ring member. The ring segment may carry one or more heads for gripping engagement with the upper tubular. A hydraulic drive motor may be provided for powering rotation of the partial ring member, the ring segment and the first tubular.

A rotational support mechanism, such as rollers and/or bearings, may be provided in the tong body to define the rotational path for the partial ring member and the ring segment. The support mechanism may also prevent spreading of the open throat in the partial ring member under high torque operations by confining radial movement or other deflection of the partial ring member or the ring segment.

A latch mechanism may be provided to secure the door to the tong body when the door is in the closed position. The latch mechanism may be at least partially secured to the door. A latch arm is pivotally moveable between a latch arm closed position and a latch arm opened position. The latch mechanism may include a latch coupling and a pivotally mounted inner latch head, both for engaging a latch stop. The latch stop may be fixedly secured to the tong body, adjacent a side of the open throat. When the door and latch mechanism and are in the closed and latched positions respectively, the inner latch head and the latch coupling may engage the latch stop and the outer latch head may engage the inner latch head to lock the inner latch head in engagement with the latch stop.

The improved open throat power tong provides for a simplified, reliable rotating mechanism in that the partial ring member and the ring segment are structurally independent from one another, both during door opening/closing, and while rotating the partial ring member and ring segment in unison to make up and/or break out a tubular connection. When the door is closed, the ring segment may substantially fill in the open throat portion of the partial ring member, essentially providing up to 360 degrees of gripping area around the tubular member. The partial ring member and ring segment substantially rotate along a common plane, at a common radius about a common axis.

During rotation, a planar or configured end surface of the ring segment may engage a similar end surface configuration of the partial ring member, however, the ring segment and partial ring member may remain structurally independent from each other. To open the door of the power tong, rotation may be interrupted when the ring segment is substantially aligned with the door in the open throat of the tong body. The door may then be opened and in so doing the ring segment may pivot out of the open throat with the door. When the door is opened or unlatched, a retainer arm may engage the ring segment to secure the ring segment within the door and to prevent the ring segment from coming out of the door while the door is opened, until the door is closed and the latch is latched, wherein the retainer arm may disengage from the ring segment. As the ring segment may be structurally independent of the partial ring member during rotation, when the door is closed the ring segment may be immediately ready for rotational operation as no pins are required to connect or align the ring segment with the partial ring member.

The present invention provides a power tong with an improved three or more jaw gripping mechanism to facilitate applying higher torque to make up and break out operations by distributing the rotational torque over a larger circumference on the tubular member than a two jaw gripping system. Such enhanced force distribution may reduce the risk of crushing the tubular while also facilitating the application of additional torque.

It is an object of the present invention to provide a high torque power tong that may incorporate at least three gripping jaws with the tong having a reduced propensity for jamming or binding of the partial ring member and/or the ring segment, during rotation. The unsecured or “floating” ring segment of the preferred embodiment is not secured to the partial ring member. A rotational guide mechanism is provided which facilitates unison rotation of both the ring segment and the partial ring member about a substantially common plane and axis, in a torque range from low to high, without requiring critical alignment between the door, tong body, partial ring member and ring segment.

It is also an object of the present invention to provide an open throat power tong with an improved door which will reliably latch the door in the closed position, and which may close with a relatively low closing force. A latch assembly is disclosed which closes reliably with relatively low closing force while also self latching in conjunction with the door closing, such that door latching is accomplished in the same operation as door closing. The preferred embodiment latch assembly increases the likelihood that the tong operator will reliably latch the door of an open throat power tong in the closed position before operating the power tong. The latching system disclosed herein is reliably self latching upon closing of the door. Alternatively, other latching mechanisms may be utilized with the ring segment and partial ring member combination.

It is a feature of the present invention that the latching mechanism securely latches the door to the tong body when the door is in the closed position, and in addition may strengthen the power tong by preventing spreading of the open throat under high torque. The latch mechanism may support load and tong deformation forces in a plurality of orientations.

It is a significant feature of the present invention that the power tong may save time and effort in opening and closing the door as the ring segment and partial ring member do not require pinning or otherwise connecting with each other. The ring segment is structurally independent from the partial ring member. The partial ring member and ring segment may be rotated in unison within the tong and door to make up or break out a connection from substantially the time the door is closed. In addition, the door may be opened substantially immediately after ceasing rotation and aligning the ring segment with the door.

It is a feature of this invention that the partial ring member may be rotated while the door is opened and the ring segment non-rotationally contained within the door. Although it is recommended that the door be closed during normal operation of the power tong, the tong door does not have to be closed for the tong to operate, and the ring segment does not have to be engaged with the partial ring member for the tong to operate. The circumferential distance between two driving idler gears in the tong body that engage the partial ring member to rotate the partial ring member is thus greater than the circumferential gap in the partial ring member. During rotation of the partial ring member while in the absence of the ring segment, e.g., when the door is opened and the ring segment is not rotating, at least one idler gear may at all times engage and drive the partial ring member. Thereby, if necessary and under special safety measures, the tong may be briefly operated with the door opened.

It is not recommended that the tong be normally operated with the door opened. The tong should only be operated with the door closed. Should special circumstances arise when may be necessary briefly to operate the tong with the door opened, extreme care, caution and special safety measures should be exercised to avoid injury.

It is also a feature of the present invention that the rotational partial ring member and ring segment may not be as susceptible to binding and jamming as may occur when ring segments and partial ring members are structurally pinned or otherwise interconnected.

Another feature of the invention is that the door for the power tong may include a single door which extends across the open throat of a power tong, or may include a pair of doors each pivotally connected to the tong body at opposing sides of the open throat of the power tong, with one of the doors supporting a latch stop thereon. In such embodiment, one of the doors may also support a head for gripping the tubular.

An advantage of the present invention is that the fatigue on the operator is reduced by significantly reducing the effort required to both close the door and concurrently latch the door in the closed position in a single operation.

Yet another advantage of the invention is that the door and the floating ring segment mechanism are reliable, simple and may be inexpensively manufactured. Binding, jamming and alignment problems may be reduced by allowing the ring segment to “flex,” “float,” move vertically or otherwise, relative to the partial ring member.

These and further objects, features, and advantages of the present invention will become apparent from the following detailed description, wherein reference is made to figures in the accompanying drawings.

### BRIEF DESCRIPTION OF THE DRAWINGS

FIG. 1 is a top view illustration of a power tong embodiment with the latch mechanism unlatched and the door opened, with the top cover partially removed.

FIG. 2 is a top view illustration of the power tong illustrated in FIG. 1, with the door closed and latched.

FIG. 3 is a bottom view of a section of the power tong with the door opened and the latch mechanism unlatched.

FIG. 4 is a cross section view of section 4-4 in FIG. 3.

FIG. 5 is a bottom view of the section of the door and latch illustrated in FIG. 3, with the door closed and the latch mechanism latched.

FIG. 6 is a three dimensional isometric view of a power tong, generally.

### DETAILED DESCRIPTION OF THE PREFERRED EMBODIMENTS

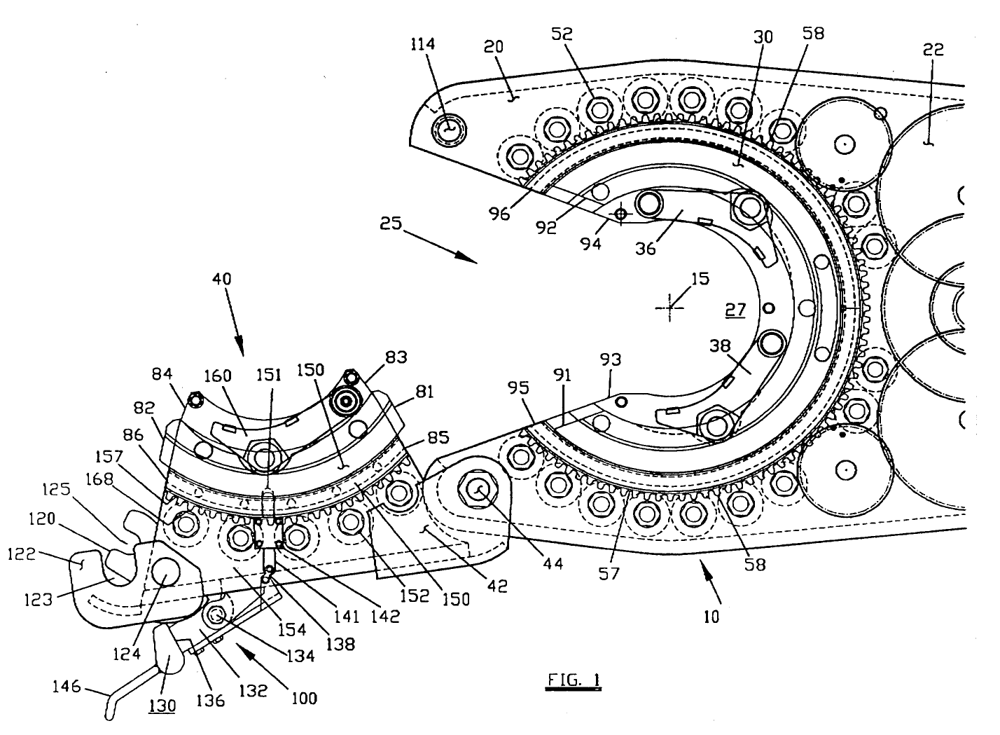

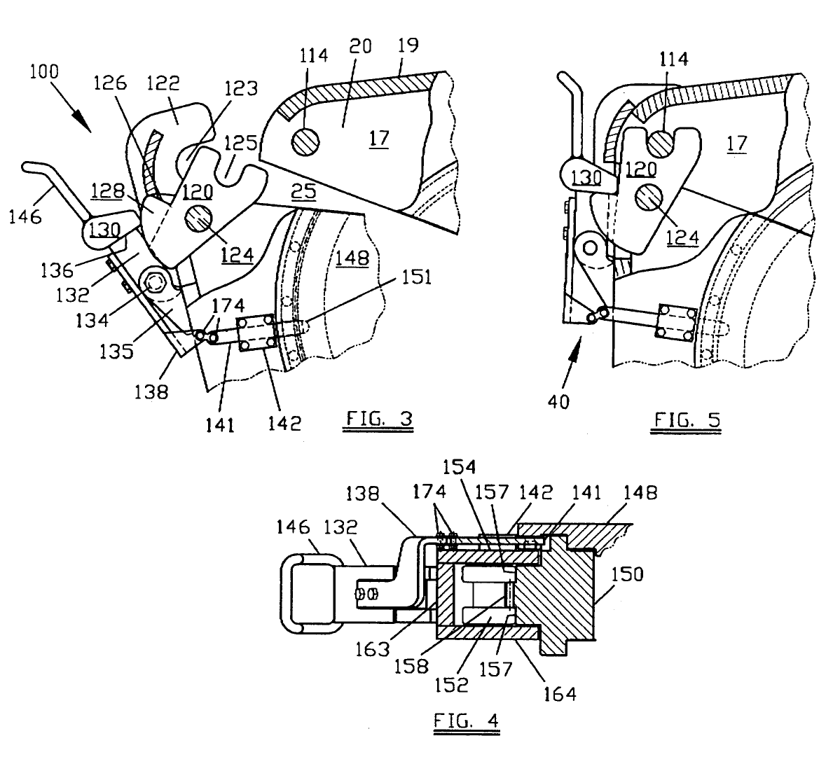

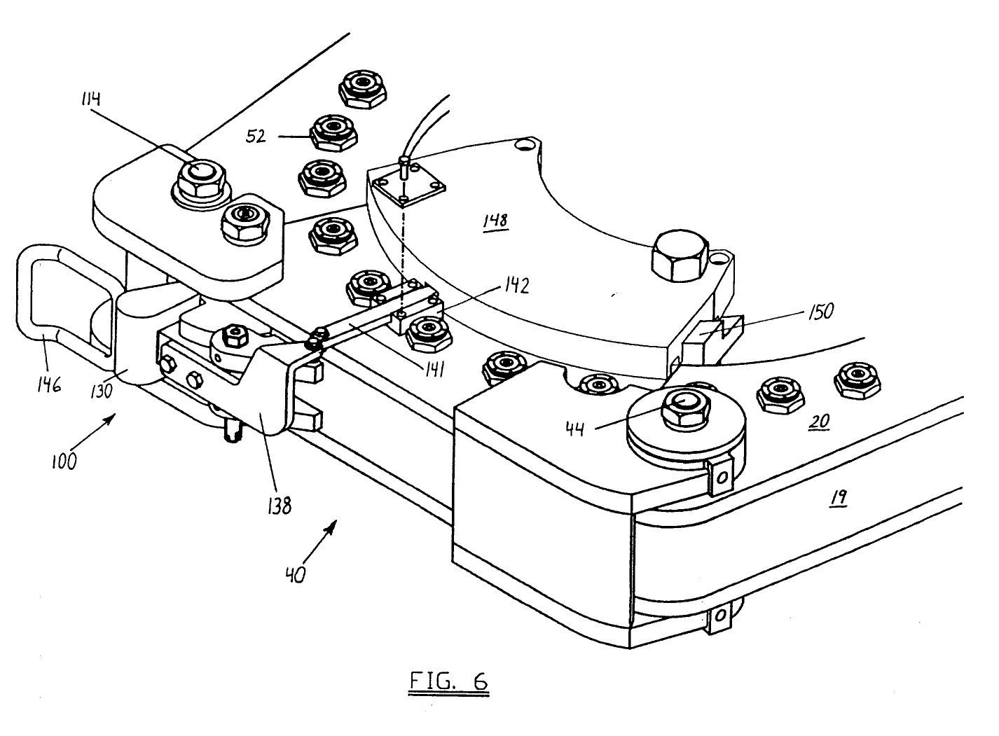

FIGS. 1-6 illustrate a generalized, suitable embodiment for an open throat high torque power tong 10 according to the present invention. A power tong door assembly 40 may be pivotally connected to a power tong body 20 by door hinge pin 44. The door assembly 40 may be opened, as illustrated in FIG. 1, exposing an open throat 25 in the power tong body 20. The power tong body 20 may include a substantial generally circular opening or central bore 27 near the back of the throat 25, the circular opening having a central axis 15. A lower end of a first tubular member 11, such as an oil field tubular pipe which may be suspended near a second end from a rig derrick (not shown), may be laterally positioned through the open throat 25 and within the central bore 27. Thereafter, the door 40 may be pivoted closed with the tong body 20 and latched by a latch mechanism 100, thereby closing the open throat 25. In such configuration, a central axis of the first tubular member 11 may be generally coaxial with the tong central axis 15.

Power may be applied to the power tong 10 to cause the power tong 10 to rotate the first tubular member 11 to make up or break out a threaded connection between first tubular member 11 and a second tubular member (not shown). The second tubular member may be typically suspended within a well bore (not shown), below the first tubular member 11. The power tong door 40 may thereafter be opened to allow the power tong 10 to be laterally removed from engagement with the first tubular member 11.

High Torque Power Tong

For a preferred embodiment as shown in FIGS. 1-6, the power tong assembly 10 may be powered, hydraulically or otherwise, to impart torque upon and rotate the first tubular member 11. A gear assembly 22 may be included in the transition of power through the tong 10. Additional tong components may include a partial ring member 30 and a plurality of jaw members engaged thereto, for gripping the first tubular member 11. The tong body 20 may provide an open throat for laterally moving the tong between engagement and disengagement with the tubular member 11. A generally circular central bore 27 near the back of the open throat 25 may be included to position the tubular member during rotation of the tubular member 11. The diameter of the circular opening 27 is large enough to accommodate the largest diameter tubular member 11 for which the particular power tong 10 is designed to rotate, plus some additional diameter to facilitate telescopic transmission of such tubular members 11 through the central bore 27 without binding the tubular 11 with the tong 10.

The tong body 20 may include an upper cage plate 17 which may substantially provide an upper cover on the tong body 20, and a lower cage plate (not shown) which may substantially provide a lower cover on the tong body 20, opposing the upper cage plate 17. A tong frame 19 may generally encompass portions of the periphery of the tong body 20, excepting for the open throat 25 and the central bore 27 portions of the tong body 20. The tong frame 19 may enclose at least a portion of an interior of the tong body 20 between and at least partially supporting the upper 17 and lower tong plates. The tong frame 19 may also extend through portions of the interior of the tong body 20.

The partial ring member 30 is designed to rotate within the tong body 20, about the central axis 15. The partial ring member 30 may include a row of gear teeth 58 on a portion of an outer periphery of the partial ring member 30 to rotationally connect the partial ring member 30 with the gear assembly 22. One or more roller guide surfaces 57 may also be provided on the partial ring member 30, preferably near an outer periphery of the partial ring member 30, to engage a plurality of tong body roller guides 52. The plurality of tong body roller guides 52 may confine rotation of the partial ring member 30 within a rotational course that may be at least partially defined by and supported by the roller guides 52. In addition, the roller guides 52 may aid in preventing spreading of the partial ring member 30 under applications of high torque by providing lateral support to the partial ring member 30.

An inner surface of the partial ring member 30 may support at least two heads 36 for selectively gripping the tubular member 11. The heads 36 may partially move or pivot radially inward toward the central axis 15 during rotation of the partial ring member 30, such that tong dies (not shown) or other tubular gripping components supported on the heads 36 may engage and grip the tubular 11. The heads 36 may also be selectively retractable such that the heads 36 may move radially outward toward the partial ring member to release the tubular 11.

The tong body 20 may support the tong door 40. The door 40 may be pivotally connected to the tong body 20 adjacent a side of the open throat 25 to extend at least partially across the open throat when the door 40 is in a closed position. When the door 40 is in an opened position the opened throat 25 is exposed, thereby enabling the power tong 10 to be moved laterally on and off tubular 11. In the closed position, the hinged end of the door 40 may be secured to the tong body 20 by hinge pin 44, while a latch end of the door 40 is secured to the tong body 20 with a latch mechanism 100 which is latched to a latch stop 114 that is secured to the tong body 20.

The door assembly 40 generally may securely close the open throat 25 and guide the partial ring member 30 and a ring segment 150, during rotation. When the door 40 is in the opened position, the door 40 may support the ring segment 150. The ring segment 150 may support at least one additional jaw member 160 for gripping the tubular 11. When the door 40 is closed, the ring segment 150 and partial ring member 30 may rotate at least partially within each of the tong body 20 and the door 40.

The door assembly 40 may include an upper frame portion 154, a lower portion 164 substantially opposing the upper frame portion 154, and an outer wall 163, generally forming a door interior. A door cage plate 148 may also be included to cover a portion of the interior of the door assembly 40.

The ring segment 150 may be designed to rotate about the central axis 15 along a defined rotational course within each of the tong body 20 and closed door assembly 40. A radially outward surface of the ring segment 150 may include a row of gear teeth 168 to connect the ring segment 150 with the gear assembly 22. One or more roller guide surfaces 157 may also be provided on the ring segment 150, preferably on an outer periphery of the ring segment 150, to engage a plurality of door roller guides 152. The plurality of door roller guides 152 may confine and support rotation of the ring segment 150 and partial ring member 30 within the door assembly 40 and tong body 20 along a rotational course at least partially defined by and supported by roller guides 52 and 152. In addition, the roller guides 152 may aid in preventing spreading of the partial ring member 30 under applications of high torque by providing lateral support to the partial ring member 30.

An inner surface of the ring segment 150 may support at least one head 160 for selectively gripping the tubular 11. The head 160 may partially move or pivot radially inward toward the central axis 15 during rotation of the ring segment 150 and partial ring member 30, such that tong dies (not shown) or other tubular gripping components supported on the heads 36 may engage and grip the tubular 11. The head 160 may also be selectively retractable such that the head 160 may move radially outward toward the ring segment 150 to release the tubular 11.

The ring segment 150 may have a radius of curvature and a general configuration that is substantially the same as the partial ring member 30, with a significant difference being that the arc length of the ring segment 150 may be less than the arc length of the partial ring member 30. The ring segment 150 may have an arc length that extends across a portion of the open throat 25 wherein the partial ring member 30 may rotate. Consequently, when the door 40 is closed, the ring segment 150 and the partial ring member 30 may substantially encircle the tubular 11 with a 360 degree arc length.

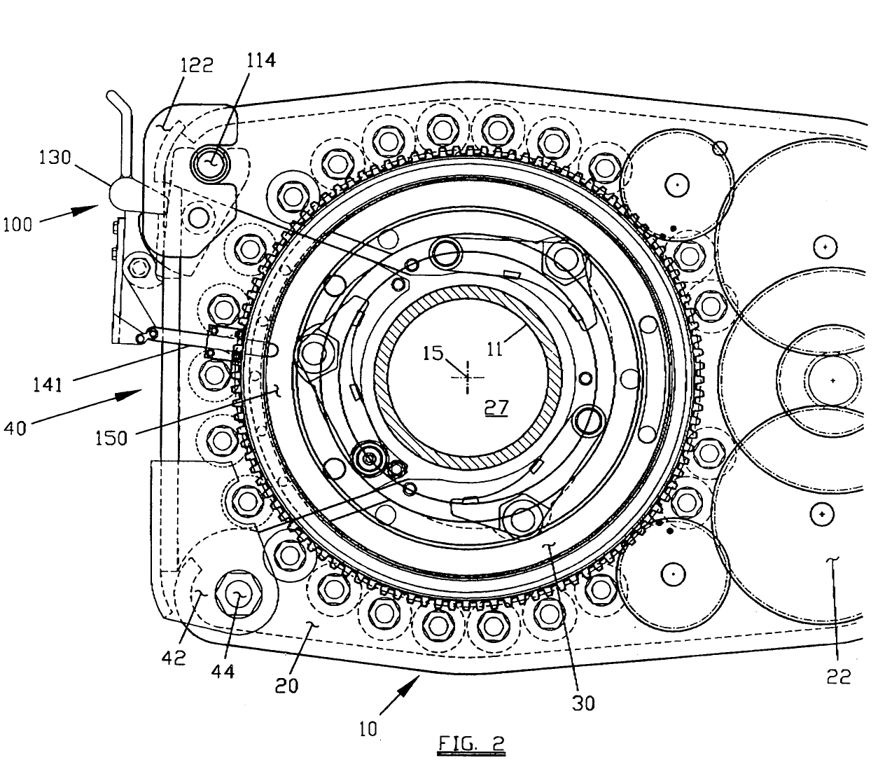

The open throat portion of the partial ring member 30 may include end surfaces 91 and 92. The ring segment 150 may include ring segment end surfaces 81 and 82. When the door 40 is closed, ring segment end surfaces 81 and 82 may substantially abut end surfaces 91 and 92 respectively. The ring segment 150 may also include ring segment end surfaces 83, 84, 85 and 86. The partial ring member 30 may include end surfaces 93, 94, 95 and 96. End surfaces 81 and 82 may be staggered from respective adjacent end surfaces 83 and 85, and 84 and 86, respectively. Likewise, end surfaces 91 and 92 may be staggered from respective adjacent end surfaces 93 and 95, and 94 and 96. A staggering arrangement of end surfaces, such as shown in FIGS. 1 and 2 or otherwise, may provide for interlocking the ring segment 150 and the partial ring member 30, without structurally connecting the two components, such as with pins. Each end of the partial ring member 30 may be substantially coplanar with a respective mating end of the ring segment 30. Consequently, as the ring segment 150 and partial ring member 30 rotate, the points of contact between end surfaces of the two components may provide for relative planar displacement and/or for “flexing” between the two components, at the interconnection points. Therefore, binding, jamming and misalignment problems may be reduced while providing a means for at least partial engagement between the two components.

The arc length of the door section 25 of the power tong 10 is relatively small as compared to the outer circumferential arc length of the partial ring member 30, such that with appropriate safety measures in place the tong 10 may be operated with the door 40 opened. A preferred embodiment of the power tong 10 includes at least two driving idler gears 23, 24. The driving idler gears 23, 24 each may impart rotation to either or both of the partial ring member 30 and the ring segment 150. The span or arc distance between two driving idler gears 23, 24 which engage the partial ring member 30 to rotate the partial ring member 30 is greater than the arc length of the gap or open throat 25 in the outer circumferential arc of the partial ring member 30. Consequently, during rotation of the partial ring member 30 while in absence of the ring segment 150 in common rotation therewith, e.g., when the door 40 is opened and the ring segment 150 is not rotating, at least one driving idler gear 23, 24 may at all times engage and drive the partial ring member 30. Thereby, under special circumstances and for brief periods, and with extra safety measures in place, the tong 10 may be briefly operated with the door 40 opened.

In alternative embodiments, end surfaces 91, 93 and 95 of the partial ring member 30 may be coplanar or angular with respect to respective end surfaces 92, 94 and 96 of the partial ring member 30. Likewise, end surfaces 81, 83 and 85 of the ring segment 30 may be coplanar or angular with respect to respective end surfaces 82, 84 and 86. Those skilled in the art will appreciate that many variations may be conceived for relational door, body and ring structure and/or design.

Latch Mechanism

The power tong may 10 may include a latch mechanism 100 partially secured to the door assembly 40 to securely retain the door 40 in the closed position. The disclosed latch mechanism 100 may be simple, reliable and easily latched and unlatched. The latch mechanism 100 may include two portions, namely, a door portion and a tong body portion.

The tong body end of the latch mechanism 100 may include a latch stop 114 which is securely affixed to the tong body 20, substantially adjacent a side of the open throat. The latch stop 114 may preferably be a single component. The door 40 portion of the latch mechanism 100 may include a door hinge bracket 42 that is secured to the door 40 and which allows the door 40 to pivot on door hinge pin 44. A latch coupling 122 may be secured to the opposing end of the door 40 to releasably engage the latch stop 114 when the door 40 is in the closed position. The latch coupling 122 may be pivotal secured to the door 40 by pin 124. The latch coupling 122 may assist in preventing spreading of the open throat 25 during applications of high torque.

A latch arm 132 may be included for latching and releasing the latch mechanism 100. The latch arm 132 may be pivotally attached to latch arm hinge member 135, by latch arm hinge pin 134. A biasing device (not shown), such as a torsion spring, may be included to bias the latch mechanism, including latch arm 132, in a closing position. Such biasing may assist and secure latching of the latch mechanism. The hinge member 135 may be immovably connected to the door body 154. The latch arm 132 may be pivotally movable between a latch arm closed position and a latch arm opened position. The latch arm 132 may include an outer latch head 130 having an inner latch head engagement surface 136 for engagement with an offset portion 128 of an inner latch head 120 to latch the door 40 when the door 40 and latch mechanism 100 are in the closed position. A latch handle 146 may be immovably secured to the outer latch head 130 to facilitate opening the latch mechanism 100.

Inner latch head 120 may be included, which is pivotally connected to the door 40. The inner latch head 120 may include a latch stop recess 125 for receiving the latch stop 114. The inner latch head 120 may include an outer latch head engagement surface 126 for engagement with the inner latch head engagement surface 136 on the outer latch head 130 when the latch mechanism 100 is in the latched position.

Prior to opening the door, the ring segment 150 may be rotated to where the ring segment 150 is substantially within the door 40. The latch mechanism 100 may be released and the door 40 opened by pivoting the door 40 out of the open throat 25. When the door 40 is in the opened position, the “floating” ring segment may be retained within the door 40 by a retainer arm 141 which may operate in conjunction with the latch mechanism 100.

Manipulation of the retainer arm 141 in conjunction with the latch mechanism may require additional components, including a retainer connector bracket 138, which may be secured to the latch arm 132. The retainer connector bracket 138 may pivot with the latch arm 132 between the latch arm opened position and the latch arm closed position. One or more retainer hinge pins 174, or other linkage mechanism, may pivotally connect the retainer connector bracket 138 and a retainer arm 141. A retainer guide 142 may be secured to the door 40 and may provide a channel to telescopically guide movement of the retainer arm 141. A retainer arm engagement port 151 may be provided in the ring segment 150 for selectively receiving the retainer arm 141.

Power Tong Operation

A high torque power tong 10 as disclosed in the preferred embodiment may preferably be hydraulically powered, including a hydraulic power source and hydraulic control system (not shown). In the door opened, open throat configuration the power tong may be laterally moved into engagement with a tubular 11. The tubular 11 may be transmitted through the open throat 25 and into the central bore 27 near the back of the open throat 25. The door 40 may be pivoted closed such that the ring segment 150 is circumferentially positioned adjacent an open throat 25 portion of the partial ring member 30. A recessed opening 123 in the latch coupling 122 may engage the latch stop 114, while a recessed opening 125 in the inner latch head 120 may engage the latch stop 114.

To secure engagement of the inner latch head 120 and the latch coupling 122 with the latch stop 114, the latch arm 132 and outer latch head 130 may be pivoted from the opened position to the closed position. The outer latch head 130 may be pivoted into engagement with the offset portion 128 of the inner latch head 120, such that the inner latch head engagement surface 136 on the outer latch head 130 may engage the outer latch head engagement surface 126 on the inner latch head 120.

As the latch arm 132 is pivoted to the closed position, the retainer connector bracket 138 which may be affixed to the latch arm 132, may concurrently pivot with the latch arm 132, wherein the retainer arm 141 may be telescopically disengaged from the recess 151 in the ring segment 150. The retainer pin 174 may connect the retainer arm 141 and connector bracket 138, and the retainer guide 142 may control movement of the retainer arm 141.

Hydraulic power may be applied to the power tong 10 to cause the engaged tubular member 11 to rotate relative to a second tubular (not shown), in a selected direction to make up or break out a threaded connection between the first tubular II and the second tubular. The power tong 10 may also be operated to rotate more than merely one joint of tubular member 11; for example, rotating a full string of connected tubulars such as when drilling, or manipulating downhole tools. Power may be transmitter through the gear assembly 22 preferably to one or more points near the radially outer periphery of the partial ring member 30 and the ring segment 150, as the partial ring member 30 and ring segment 150 are rotated within the tong body 20 and door 40. Rotational movement of the partial ring member 30 and ring segment 150 may cause the plurality of jaw members 36, 38, 160 to partially move radially inward to engage and grip the tubular member 11, such that the tubular 11 is rotated in conjunction with the partial ring member 30 and ring segment 150. Torque may be relaxed or rotation reversed, causing the jaws 36, 38, and 160 to disengage from the tubular 11 and retract radially outward away from the tubular 11. The tubular may then be moved telescopically up or down through the central bore 25. Subsequent connections may be thereafter selectively made up, broken out and/or otherwise rotated.

To laterally remove the power tong 10 out of engagement from a tubular 11 that is positioned with the central bore 27, the partial ring member 30 and ring segment 150 may be rotated until the ring segment 150 is substantially positioned within the door 40 and the retainer arm engagement port 151 is aligned with the retainer arm 141. The latch mechanism 100 may be unlatched, the door 40 opened and the tong 10 moved laterally out of engagement with the tubular II. To unlatch the latch mechanism 100, an operator may pull laterally outward on the handle 146, away from the door 40, causing the outer latch head 130 to disengage from projection 128 on the inner latch head 120. Concurrently, the retainer connector bracket 138 may cause the retainer arm 141 to partially telescopically penetrate into the retainer arm engagement port 151 to secure the ring segment 150 within the door 40 while the door 40 is in the opened position.

The door 40 may thereafter be pivoted from the closed position within the tong throat 25 to an opened position, thereby exposing the open throat 25. The power tong 25 may be laterally removed from engagement with the tubular 11. Because the partial ring member 30 is not secured to the ring segment 150, in lieu of or prior to removal of the power tong from engagement with the tubular 11 the partial ring member 30 and tubular 11 may be rotated with the door 40 opened and the ring segment removed. In such instance, the partial ring member 30 may traverse the open throat within the rotational course, without the presence or assistance of the door 40. Normal tong operation with the door opened is not recommended. Injury may result from tong 10 operations with the door 40 opened, due to exposure of moving components within the tong 10.

In an alternative embodiment of an open throat power tong assembly 10 which provides for a floating ring segment 150 in the door 40, the inner latch head 120 may be pivotally mounted on the latch coupling 122. Also, in alternative embodiments, the retainer arm mechanism 138, 141, 142, 151, and 174 may be of a mechanical configuration other than as disclosed above, such as a friction mechanism, a variation on the disclosed pin configuration, magnets, or a clamp mechanism. Some power tong 10 embodiments may completely eliminate the retainer mechanism and retain the ring segment 150 within the door 40 by close tolerance component fit, or otherwise.

It may be appreciated that various changes to the details of the illustrated embodiments and systems disclosed herein may be made without departing from the spirit of the invention. While preferred embodiments of the present invention have been described and illustrated in detail, it is apparent that still further modifications and adaptations of the preferred and alternative embodiments will occur to those skilled in the art. However, it is to be expressly understood that such modifications and adaptations are within the spirit and scope of the present invention, which is set forth in the following claims.

What is claimed is:

1. A power tong for making up and breaking out a threaded connection between a first tubular member extending in a first direction from the connection and a second tubular member extending in a second direction from the connection, the power tong selectively rotating the first tubular member with respect to the second tubular member in one of a make up direction and a break out direction, the power tong comprising:
a tong body with an open throat therein;
a partial ring member rotatable relative to the tong body about a central axis, to rotate the first tubular member within the tong body, the partial ring member having a ring throat for selective alignment with the open throat in the tong body;
a plurality of jaw members rotatable with the partial ring member for gripping the first tubular member;
a door pivotally connected to the tong body adjacent a side of the open throat to extend at least partially across the open throat when in a closed position and to expose the open throat of the power tong when in the opened position to enable the power tong to be moved laterally on or off the first tubular member;
a floating ring segment structurally disconnected from the partial ring member while rotating with the partial ring member about the central axis, relative to the tong body, the floating ring segment positioned within the ring throat of the partial ring member, and the floating ring segment carrying at least one of the plurality of jaw members; and
a power source for rotating at least the partial ring member.

2. The power tong as defined in claim 1, wherein the plurality ofjaw members includes two jaw members rotatably attached to the partial ring member and one jaw member rotatably attached to the floating ring segment.

3. The power tong as defined in claim 1, further comprising:
two or more drive gears in a gear assembly, at least one of the two or more drive gears being in continuous contact with the partial ring member.

4. The power tong as defined in claim 3, wherein a first axial center of a first drive gear and a second axial center of a second drive gear, respectively, of the two or more drive gears are circumferentially fixed with respect to the tong body, and an arc length in degrees between the axial center of the first drive gears and the axial center of the second drive gear is greater than the arc length in degrees of the ring throat of the partial ring member.

5. The power tong as defined in claim 3, further comprising:
a plurality of ring member gear teeth disposed on a radially outward surface of the partial ring member; and
a plurality of drive gear teeth disposed on a radially outward surface of each of the two or more drive gears to interconnect the partial ring member and the two or more drive gears.

6. The power tong as defined in claim 3, further comprising:
a plurality of floating ring gear teeth disposed on a radially outward surface of the floating ring segment; and
a plurality of drive gear teeth disposed on a radially outward surface of each of the two or more drive gears to interconnect the floating ring segment and the two or more drive gears.

7. The power tong as defined in claim 1, further comprising:
a ring guide mechanism at least partially disposed within the tong body and partially disposed within the door, to guide the partial ring member and the floating ring segment during rotational movement of the partial ring member and floating ring segment.

8. The power tong as defined in claim 7, wherein the ring guide mechanism further comprises:
a plurality of rollers to engage the partial ring member and the floating ring segment, wherein each of the plurality of rollers rotate relative to the tong body.

9. The power tong as defined in claim 1, wherein the door further comprises:
a door body pivotal about an axis between a throat opened positioned and a throat closed position; and
a door latch to secure the door to the tong body, in the closed position.

10. The power tong as defined in claim 9, wherein the door latch comprises:
a first latch member attached to the door; and
a second latch member attached to the tong body near the open throat for latching engagement with the first latch member.

11. The power tong as defined in claim 10, wherein:
the second latch assembly includes a latch stop affixed to the tong body adjacent a side of the open throat; and
the first latch member includes a latch arm pivotally connected to the door and movable between a latch arm closed position and a latch arm opened position, an outer latch head having an inner latch head engagement surface, a latch coupling secured to the door to releasably engage the latch stop when the door is in the closed position, and an inner latch head having a latch stop recess for receiving the latch stop therein and an outer latch head engagement surface for engagement with the inner latch head engagement surface on the outer latch head when both the door and the latch arm are in the closed position.

12. The power tong as defined in claim 11, further comprising:
a ring segment retainer that is movably responsive to movement of the door latch for releasably retaining the floating ring segment within the door while the door is in the opened position and for releasing the floating ring segment from engagement from the door when the door is closed.

13. The power tong as defined in claim 1, further comprising:
a ring segment retainer that is movably responsive to movement of the door latch for releasably retaining the floating ring segment within the door while the door is in the opened position and for releasing the floating ring segment from engagement from the door when the door is closed.

14. The power tong as defined in claim 1, wherein the power source further comprises:
at least one hydraulic motor; and
an operator control mechanism for controlling fluid flow to the hydraulic motor.

15. The power tong as defined in claim 1, further comprising:
a ring segment retainer for releasably retaining the floating ring segment within the door while the door is in the opened position.

16. An open throat power tong for making up and/or breaking apart a tubular connection, the open throat power tong comprising:
a tong body having an open throat therein;
a partial ring member rotatable relative to the tong body about a central axis, to rotate the first tubular member within the tong body, the partial ring member having a ring throat for selective alignment with the open throat in the tong body;
a plurality of jaw members rotatable with the partial ring member for gripping the first tubular member wherein the plurality of jaw members includes two jaw members rotatably attached to the partial ring member and one jaw member rotatably attached to the floating ring segment;
a door pivotally connected to the tong body adjacent a side of the open throat to extend at least partially across the open throat when in a closed position and to expose the open throat of the power tong when in the opened position to enable the power tong to be moved laterally on or off the first tubular member;
a power source for rotating at least the partial ring member;
at least one hydraulic motor;
a control mechanism for controlling fluid flow to the hydraulic motor;
a latch stop affixed to the tong body adjacent a side of the open throat;
a latch coupling secured to the door to releasably engage the latch stop when the door is in the closed position;
a latch arm pivotally connected to the door and movable between a latch arm closed position and a latch arm opened position, the latch arm including an outer latch head having an inner latch head engagement surface; and
an inner latch head pivotally connected to one of the door and the latch coupling, the inner latch head having a latch stop recess for receiving the latch stop therein and an outer latch head engagement surface for engagement with the inner latch head engagement surface on the outer latch head.

17. A power tong door for connecting a first side of an open throat in an open throat power tong and a second side of the open throat in the open throat power tong, the door being movable between an opened position and a closed position to enable the power tong to be moved laterally or off a tubular member, the power tong including a tong body having an open throat therein, a partial ring member rotatable relative to the tong body about a central axis, relative to the tubular member within the tong body, the partial ring member having a ring throat for selective alignment with the open throat in the tong body, a plurality of jaw members rotatable with the partial ring member for gripping the first tubular member wherein the plurality of jaw members includes two jaw members rotatably attached to the partial ring member and one jaw member rotatably attached to the floating ring segment, the power tong door comprising:
a door body connected to the first side of the open throat power tong to extend at least partially across the open throat when in a closed position and to expose the open throat of the power tong when in the opened position;
a latch stop affixed to the tong body adjacent a side of the open throat;
a latch coupling secured to the door to releasably engage the latch stop when the door is in the closed position;
a latch arm pivotally connected to the door and movable between a latch arm closed position and a latch arm opened position, the latch arm including an outer latch head having an inner latch head engagement surface; and
an inner latch head pivotally connected to one of the door and the latch coupling, the inner latch head having a latch stop recess for receiving the latch stop therein and an outer latch head engagement surface for engagement with the inner latch head engagement surface on the outer latch head.

18. The power tong door as defined in claim 17, further comprising:
a floating ring segment; and
a ring segment retainer for releasably retaining the floating ring segment within the door for preventing the floating ring segment from becoming dislodged from the door while the door is in the opened position and for releasing the floating ring segment from engagement from the door when the door is closed.

19. A power tong latch mechanism for latching a door to a power tong having an open throat therein for moving the power tong on and off a first tubular member, the power tong selectively rotating the first tubular member with respect to the second tubular member in one of a make up direction and a break out direction, the latch mechanism comprising:
a latch stop affixed to the power tong adjacent a side of the open throat;
a latch coupling secured to the door to releasably engage the latch stop when the door is in the closed position;
a latch arm pivotally connected to the door and movable between a latch arm closed position and a latch arm opened position, the latch arm including an outer latch head having an inner latch head engagement surface; and
an inner latch head pivotally connected to one of the door and the latch coupling, the inner latch head having a latch stop recess for receiving the latch stop therein, and the inner latch head having an outer latch head engagement surface for engagement with the inner latch head engagement surface on the outer latch head.

20. The power tong latch mechanism as defined in claim 19, further comprising:
a ring segment retainer guide for providing a passageway for guiding movement of the ring segment retainer.

21. The power tong latch mechanism as defined in claim 19, further comprising:
a ring segment retainer connector for pivotally securing the ring segment retainer to the latch arm.

22. A method of making up and breaking out a threaded connection between a first tubular member and an axially aligned second tubular member with an open throat power tong, the power tong selectively actuatable for rotating the first tubular member with respect to the second tubular member in one of a makeup direction and a breakout direction, the method comprising:
providing a tong body having an open throat therein;
providing a partial ring member rotatable relative to the tong body about a central axis, the partial ring member having a ring throat for selective alignment of the ring throat with the open throat in the tong body;
pivotally connecting a door to the tong body adjacent a side of the open throat to extend at least partially across the open throat when in a closed position and to expose the open throat of the power tong when in the opened position to enable the power tong to be moved laterally on or off the first tubular member;
structurally supporting a floating ring segment within the door when the door is opened, the floating ring segment being structurally disconnected from a partial ring member, the floating ring segment being simultaneously rotatable with the partial ring member about the central axis relative to the tong body when the door is closed;
providing a power source for rotating at least the partial ring member;
thereafter opening the door with the ring segment structurally supported by the door; and
thereafter rotating the partial ring member relative to the tong body about a central axis with the door opened.

23. The method of making up and breaking out a threaded connection as defined in claim 22, further comprising:
substantially aligning the ring throat in the partial ring member and the open throat in the power tong;
thereafter pivoting the door to the closed position to position the ring segment within the ring throat of the partial ring member; and
thereafter activating the power source to simultaneously rotate the partial ring member and the floating ring segment about the central axis.

24. The method of making up and breaking out a threaded connection as defined in claim 22, further comprising:
substantially aligning the ring throat in the partial ring member and the open throat in the tong body;
thereafter laterally passing the first tubular member through the ring throat and the open throat to substantially align the first tubular member with the central axis in the tong body;
thereafter gripping the first tubular member with a plurality of jaw members rotatable with the partial ring member for gripping the first tubular member; and
thereafter rotating the partial ring member and the plurality of jaw members relative to the tong body about a central axis to rotate the first tubular member.
